(19) United States
(12) Patent Application Publication
(10) Pub. No.: US 2010/0308128 A1
(43) Pub. Date: Dec. 9, 2010

(54) DETONATION FLAME SPRAY APPARATUS

(75) Inventors: Koh-ichi Hayashi, Kanagawa (JP); Hiroyuki Satoh, Kanagawa (JP); Hirotaka Fukanuma, Tokyo (JP); Naoyuki Ohno, Tokyo (JP)

Correspondence Address: MALLOY & MALLOY, 2800 S.W. THIRD AVENUE, HISTORIC CORAL WAY, MIAMI, FL, 33129, US

(73) Assignee: TAMA-TLO CO., LTD., Tokyo (JP)

(21) Appl. No.: 12/440,505

(22) PCT Filed: Feb. 13, 2009
(86) PCT No.: PCT/JP2009/052393

§ 371 Date: Aug. 18, 2009

(51) Int. Cl. B05B 1/24

(52) U.S. Cl. 239/13; 239/79; 239/85

(57) ABSTRACT

The present invention aims to provide a novel detonation flame spray apparatus which makes it possible to attain stable detonation flame spraying while using a hydrogen fuel.

In the detonation flame spray apparatus, stable pulsed detonation with short DDTL has been attained by oppositely injecting hydrogen and oxygen while separating a sub-combustion room and a main combustion room to which a spiral ridge is formed at an inner wall. In addition, by distributing supply ports of flammable gas to the sub-combustion room and a rear end of the main combustion room, high frequency operation can be realized while assuring necessary heat amounts for fusing flame spray material and a mechanism for supplying intermittently the flame spray material to together with the hydrogen fuel has realized enhancement of flame spraying efficiency.

The present invention relates to a detonation flame spray apparatus, and more particularly relates to the detonation flame spray apparatus using hydrogen as a fuel therefor.

### BACKGROUND ART

A detonation flame spraying method has been invented by R. W. Poorman, H. B. Sargent and H. Lamprey of Union Carbide Corporation in 1955 and has been so far applied to various fields as one of the most excellent flame spraying method. Now, the spraying process of the detonation flame spraying will be summarized as below: First, an admixture of a fuel gas, an oxidizer, and powdery flame splay material is charged in a tubular detonation chamber comprising a closed end and an open end. Next, the admixture is ignited by a spark plug to cause the explosion which forms a detonation wave in the detonation chamber. The flame spray material is heated and accelerated by sudden and severe expansions of reaction product gases after the front of detonation wave has passed through and is discharged from the open end with a high velocity. Particles of the flame spray material hit a substrate surface, then spread, and adhere thereon to form a coating film.

In the conventional detonation flame spray set forth, usually hydro-carbon fuels such as acetylene etc. are used; however, there is a defect that carbon is included as impurity in the formed flame sprayed film when the hydro-carbon fuels is used. In addition, the acetylene is extremely reactive, and hence there was another problem which the safe handling of the flame spray apparatus becomes difficult.

With respect to the above defects, hydrogen with lower reactivity than that of acetylene has been tried to use as the fuel. When hydrogen was used as the fuel, a distance to Deflagration to Detonation Transition Length (DDTL) becomes longer than the DDTL of the acetylene fuel such that there was further another problem that a detonation chamber length has to become longer and inevitably the flame spray apparatus becomes large.

In relation to the above, prior arts patent applications (hereafter referred to patent Literatures 1-3) disclose basic ideas for the detonator trying to shorten the Deflagration to Detonation Transition Length (hereafter referred to DDTL) and for application to the flame spray apparatus while using hydrogen.

### Patent Literature 1: Japanese Patent (Laid-Open) No. 2006-250382

### Patent Literature 2: International Patent Publication No. 2007/099768

### Patent Literature 3: Japanese Patent (Laid-Open) No. 2008-272622

### DISCLOSURE OF INVENTION

### Problem Solved by Invention

The present invention has been made by considering the above problems and defects in the prior arts, and hence an object of the present invention is to provide a novel detonation flame spray apparatus which enables stable flame spray by using the hydrogen fuel.

### Means for Solving Problem

In the course of developments about the detonation flame spray apparatus of an acceptable size while using hydrogen fuel having relatively easy handling property, the inventors have reached an idea of the detonator with the shortened DDTL having the feature comprising a partition wall with a plurality of through holes, the partition wall being positioned near an ignition point and a ridge spirally extending along to and integrated to an inner wall of the detonation tube which is placed adjacent to the wall. Furthermore, upon applying the above idea to the detonation flame spray apparatus for practicing thereof, the present invention has been completed as the result of the developments about the features with which a stable and high frequency operation may be attained even by using hydrogen with lower reactivity than acetylene.

Thus, the inventors have practically found that the stable pulsed detonation may be attained with the short DDTL in the detonation flame spray apparatus with the features in which a sub-combustion room and a main combustion room which the spiral ridge integrally formed on the inner wall thereof are separated by a partition wall with a plurality of through holes together with the additional feature in which hydrogen and oxygen are injected oppositely into the sub-combustion room. In addition, by distributing supply ports in the sub-combustion room and a rear end of the main combustion room, it has been practically proofed that a high frequency operation is achieved while keeping heat amounts required for melting flame spray material. Furthermore, it is practically proofed that the features in which the flamed spraying material is supplied intermittently together with the hydrogen fuel enhances flame spray efficiency. Further in addition to the above, members each separately cooling about an outer circumference of the combustion chamber and inside of the partition wall allow long term continuous operation.

### BEST MODE FOR PRACTICING INVENTION

Hereinafter, the present invention will be explained together with the embodiments depicted in drawings; however, the present invention must not be limited by the practical embodiments illustrated in the drawings. Now, in each drawings referred hereunder, the same or similar elements are referred by using the same reference numbers and each detailed descriptions therefor will be omitted.

FIG. 1 shows a side view of a detonation flame spray apparatus 100 of the present invention. The detonation flame spray apparatus 100 depicted in FIG. 1 adopts a pipe-flange structure allowing easy dismantlement and assembly depending on particular requirements for maintenances etc. More particularly, the detonation flame spray apparatus 100 comprises unit 10, unit 20, unit 40, unit 60, and unit 70 as provided in flange-like members together with unit 30, unit 50, and unit 50 as provided in tubular members each having flanges; the members set forth are connected through the flanges to define a combustion chamber as a tubular space having a closed end and an open end.

The unit 10 comprises a sub-combustion room for generating initial flames; the unit 30 comprises a main combustion room for generating the detonation waves. In turn, the unit 20 comprises a multiple-holed partition wall for separating the sub-combustion room and the main combustion room; the unit 40 comprises a mechanism for supplying the flame spray material. Furthermore, the unit 50 comprises a room for fusing the flame spray material and the room is prepared for heating, accelerating and fusing the powder of the flame spray material supplied; the unit 60 comprises a squeeze mechanism for assuring residence time of the flame spray material. Now, each of the set forth units may be made from refractory materials such as stainless steel, duralumin, titanium alloys, nickel super-alloys etc.

The detonation flame spray apparatus 100 of the present embodiment utilizes hydrogen as the fuel and oxygen as the oxidizer in the view point of environmental loads and safety. Oxygen may be adequately supplied in an adequate form of oxygen gas (O₂), air, and/or ozone. In the detonation flame spray apparatus 100, hydrogen and oxygen are supplied to the sub-combustion room of the unit 10 and the gases supplied and mixed in the sub-combustion room are ignited by a pulse-driven ignition means 11 to generate the initial flames. The generated initial flames in the unit 10 are then introduced into the main combustion room of the unit 30 through the multi-holed partition wall (not shown) of the unit 20 and are developed to the detonation waves during the passage through the unit 30. The powder (P) of the flame spray material is supplied together with nitrogen from a flame spray material supply means of the unit 40 and is then heated, accelerated, and fused by the detonation wave energy propagating from the main combustion chamber during the passage thereof through the room for fusing the flame spray material in the unit 50. The fused flame spray material is then discharged from the open end and hits the surface of the substrate to form the film 90.

Furthermore, the detonation flame spray apparatus 100 of the present embodiment equips a water cooling mechanism for realizing the stable operation thereof. With respect to the above, more particular descriptions with referring to FIG. 2 will be provided. FIG. 2 shows a vertical cross section of the detonation flame spray apparatus 100. Here, in the description provided hereunder, a vertical cross section refers the cross section along with the longitudinal direction of the detonation flame spray apparatus 100 and a lateral cross section refers to the cross section perpendicular to the longitudinal direction of the detonation flame spray apparatus 100.

As illustrated in FIG. 2, a cylindrical combustion room 101 is formed inside of the detonation flame spray apparatus 100. In addition, the units 30, 50, 50, which are tubular members each equipping the flange, each comprises double tube structures within which cylindrical cavities are defined. As the result, the continuous cavity extending from the unit 10 to the unit 70 is formed at the outer circumference of the combustion room 101 of the detonation flame spray apparatus 100; the continuous cavity serves the flow path for a cooling medium. In the present embodiment, though there is no particular limitation on the cooling medium, the subsequent descriptions will be provided by assuming that water is adopted as the cooling medium. That is, the coolant water (W) introduced from a coolant water inlet 12 of the unit 10 flows down through inside of the unit 20-unit 60 and then is discharged from a cooling water discharge port 71 of the unit 70. Hereinabove, while the entire construction of the detonation flame spray apparatus 100 of the present embodiment has been resumed, now, the structure of each units constructing the detonation flame spray apparatus 100 will be detailed.

FIG. 3 illustrates the unit 10 and the unit 20 according to the present embodiment. FIG. 3(a) shows the vertical cross sections of the unit 10 and the unit 20. Now in FIG. 3, the unit 30 is also depicted in broken lines for supporting the clearness of descriptions. In addition, FIG. 3 (b) illustrates the lateral cross section of the unit 10 along to the line A-A and FIG. 3(c) illustrates the lateral cross section of the unit along to the line B-B.

As shown in FIG. 3(a), the unit 10 and the unit 20 are each constructed as circular flange-like members. The unit 10 comprises a hydrogen gas supply port 13 for supplying hydrogen (H₂) as the fuel, an oxygen gas supply port 14 for supplying oxygen (O₂) as the oxidizer, and a nitrogen gas supply port 15 for supplying nitrogen (N₂) as a flushing gas. Gas flow paths each extending from the gas supply ports are fluid-communicated to the sub-combustion room 16 being defined the inside portion being generally shaped to a cylinder.

Each of the above gas supply ports is constructed with a solenoid-driven injection valve and each of the injection valve is set to the pulsed operation by a control device (not shown) to supply intermittently the gases into the sub-combustion room 16. In the present embodiment, as shown in FIG. 3(b), each of gas supply ports communicated to the hydrogen supply port and the oxygen supply port 14 is aligned such that the injection directions thereof are set to the opposite direction each other. Similarly, each of the gas supply ports communicated to each of the nitrogen supply ports is also disposed such that the injection directions thereof to the sub-combustion room 16 direct oppositely each other.

In addition to the above, a spark plug as the ignition means 11 is inserted to the unit 10 such that the electrode thereof is adjacent to the inside of the sub combustion room 16. The ignition means 11 is set in the pulsed control by a controller device (not shown) so as to ignite intermittently. Here, the ignition means 11 of the present embodiment is not limited to spark plugs and the ignition means 11 may adopt a laser irradiation system.

Furthermore, a toroidal shaped cavity a is formed around the sub-combustion room 16 and a plurality of coolant water flow paths communicated to the cavity a are formed. In addition, the unit 10 is disposed with a coolant water inlet port 12 for introducing the coolant water and the coolant water inlet port 12 is fluid-communicated to the cavity a.

On the other hand, the unit 20 comprises a partition wall 21 positioned around the center portion thereof. The partition wall 21 is disposed with nine through holes 22 arranged in a regular square lattice for allowing the initial flames to make turbulence flows. The numbers of the through holes 22 and the arrangement thereof may not be limited to the example shown in FIG. 3; however, in the illustrated embodiment the covering ratio, which corresponds to the ratio of the surface area of the partition wall 21 including opening region of the through holes 22 to the surface area of the partition wall except the opening area of the through holes 22, may be between 0.7 and 0.9, may more preferably be between 0.75 and 0.85. In addition, coolant water flow paths are disposed around the partition wall 21. The unit 20 is disposed between the unit 10 and the unit 30, and the units 10, 20, and 30 are connected via. the flanges by using bolt-nut structures so that toroidal cavity b and c are defined there-between.

By mutual connections through the flanges among the units 10, 20, and 30, the sub-combustion room 16 of the unit 10 and the main combustion room 31 of the unit 30 are separated by the partition wall 21 and the cavity b and the cavity c are fluid-communicated each other through the coolant water flow path 23. In turn, in the flange 35 of the unit 30, a plurality of coolant water flow paths are disposed for providing fluid-communications between the cavity c and the cylindrical coolant water flow paths 37. The cooling water introduced from the cooling water inlet port 12 of the unit 10 is guided to the cooling water flow path 37 of the unit 30 through the cavity a, the cooling water flow path 17, the cavity b, the cooling water flow path 23, the cavity c and then the cooling water flow path 32.

In the above embodiment, the unit 20 further comprises a cooling means for separate cooling of the partition wall 21, which will be detailed in elsewhere. Although the unit 10 and the unit 20 have been mainly described hereinbefore, the unit 30 comprising the main combustion room for generating the detonation waves will be detailed.

FIG. 4 shows the unit 30 of the present embodiment. FIG. 4(a) shows the vertical cross section of the unit 30. In FIG. 4 (a), the front view and the cross section along to the line C-C of the flange part of the unit 30 are also depicted. As depicted in FIG. 4(a), the unit 30 is constructed as the cylindrical member equipped with the flanges including the doubled tube structure. More particularly, the unit 30 comprises an inner tube 33 defining the main combustion room, an outer tube 34, and two flanges 35, 36 such that the unit 30 is formed by inserting the inner tube 33 into the outer tube 34 in the configuration described above and the both ends of each tubes to each of the flanges 35, 36 are connected. As indicated by the cross section along with the line C-C, the cylindrical cavity is defined by the outer wall of the inner tube 33 and the inner wall of the outer tube 34 to provide the function of the coolant water flow path 37. As described above, the cooling water passed through the units 10, 20 flows into the cooling water flow path and then flows down to the unit 33.

FIG. 4(b) illustrates a partial cut-away view of the inside of the tube with enlarging the inside tube 33 consisting the main combustion room 31 while cutting the part of the tube wall away. As shown in FIGS. 4(a) and (b), the ridge 38 which is integral to the inner tube and protrudes towards the center thereof is formed and the ridge 38 extends spirally along to the longitudinal direction. According to the described embodiment, since the ridge 38 is integrally formed with the inner wall of the inner tube 38, the heat generated associated to the repeated pulsed detonation in the inner tube 33 may be put in efficient thermal exchange through the ridge 38 with the cooling water flowing down in the cooling water flow path 37. Hereinabove, the structures of the units 10, 20, and 30 in the detonation flame spray apparatus 100 have been described. Subsequently, the process for generating the detonation in the detonation flame spray apparatus 100 in the present embodiment will be detailed with referring to FIGS. 3 and 4.

In the present embodiment, first hydrogen and oxygen are injected oppositely into the sub-combustion room 16 of the unit 10 through the hydrogen gas supply port 13 and the oxygen gas supply port 14 being synchronously driven with the ignition means 11 to mix both gases. In the present embodiment, the hydrogen and the oxygen are preferably controlled such that the injections thereof are terminated in the same time and are supplied in the equivalent ratio of 1.0.

In turn, the ignition means 11 is operated in the pulsed mode such that the ignition takes place at the same time with the injection termination timing of the hydrogen and the oxygen; the hydrogen-oxygen gas mixture gets ignited by sparks of the ignition means 11 to form the initial flames. Subsequently, the nitrogen supply ports 15, 15 are started the pulsed operation after a predetermined time delay to the ignition timing of the ignition means 11 and then the flashing nitrogen gases are oppositely injected before the next injection timing of the hydrogen and oxygen to discharge flammable gas remaining inside the combustion room to the outside thereof. In the present embodiment, since the hydrogen and the oxygen are injected oppositely to the sub-combustion room 16, short time and even mixing thereof may be attained so that the generation of stable initial flames may be realized.

The initial flames generated in the sub-combustion room 16 is then introduced to the main combustion room 31 of the unit 30 through a plurality of through holes 22 provided with the partition wall 21. In this state, the initial flames are transformed to the turbulence flow corresponding to the plural through holes 22 and are then discharged into the main combustion room 31. The initial flames discharged into the main combustion room 31 as the plural turbulence flow then generate plural compression waves due to the presence of spirally formed ridge 38 during the propagation thereof in the main combustion room 31 to the open end thereof. The generated compression waves cause the transition from an explosive burning state to an explosive roar (detonation) state during the process of propagating thereof by enhancing each other with the reflection toward the center of the main combustion room (inner tube 33) while increasing the energy of the shock wave.

From the above description, in the detonation flame spray apparatus 100, the stable pulsed detonation is realized in short DDTL by multiple interactions from the turbulent action to the initial flames by the through holes 22 formed to the partition wall 21 and the creation and/or enhancement actions due to the spirally formed ridge 38. This fact makes it possible to reduce the length of the detonation flame spray apparatus which uses the hydrogen fuel into a practical scale (about 1000 mm). Hereinbefore, the process for generation of the detonation in the detonation flame spray apparatus according to the present embodiment has been described. Next, the cooling mechanism of the partition wall 21 disposed to the unit 20 will be explained with referencing FIG. 5.

FIG. 5(a) shows the vertical cross section of the unit 20 and FIG. 5(b) shows a front view of the cooling mechanism of the partition wall 21 disposed to the unit 20. As shown in FIG. 5(b), the center portion of the unit 20 is disposed with the disk-like shaped partition wall 21 for separating the sub-combustion room 16 of the unit 10 and the main combustion room 31 of the unit 30. To the partition wall 21, nine through holes 22 are formed. As described before, the initial flames generated in the sub-combustion room 16 reaches to the main combustion room 31 through the through holes 22 of the partition wall 21. In this condition, the partition wall 21, which is disposed in the vertical position that blocks the propagation of the initial flames, is steadily attacked by high temperature flames such that the partition wall is placed under the thermally severe condition for ling time. To address the above condition, the inventors have disposed a novel cooling mechanism to the partition wall 21.

As shown in FIG. 5(b), two cooling water inlet ports 24, 25 and two cooling water output ports 26, 27 are disposed to the unit 20; the cooling water inlet port 24 and the cooling water output port 26 are fluid-communicated by four vertical flow paths 28; the cooling water inlet port 25 and the cooling water output port 26 are fluid-communicated by four vertical flow paths 28; the cooling water inlet port 25 and the cooling water output port 27 are fluid-communicated by four lateral flow paths. Here, the vertical flow paths 28 are arranged such that the vertical flow paths 28 pass through the partition wall 21 with flowing between nine through holes 22 vertically and the lateral flow paths 29 are arranged such that the lateral flow paths 29 pass through the partition wall 21 with flowing between nine through holes 22 laterally. As the result, the vertical flow paths 28 and the lateral flow paths 29 are arranged as a lattice-like shape in the partition wall 21 as shown in FIG. 5(B).

In the detonation flame spray apparatus of the present embodiment, the cooling water (W) is steadily introduced from the cooling water inlet ports 25, 25 under the operation thereof and the introduced cooling water (W) is exhausted from the cooling water output ports 27, 27 after each passing through four vertical flow paths 28 and lateral flow paths 29. The vertical flow paths 28 and the lateral flow paths 29 of the present embodiment each pass through the partition wall 21 across the spacing between nine through holes 22, and hence the partition wall 21 may be effectively and evenly cooled. By the cooling mechanism described above, thermal deformation and thermal damage of the partition wall 21 may be adequately avoided so as to assure the safe and continuous operation of the detonation flame spray apparatus 100. Hereinabove, the cooling mechanism of the partition wall 21 formed to the unit 20 has been explained, subsequent description will provide the explanation for the unit 40 comprising the flame spray material supply mechanism for the present detonation flame spray apparatus 100.

FIG. 6 shows the unit 40 of the present embodiment and FIG. 6(a) is the vertical cross section and FIG. 6(b) is the lateral cross section along to the line D-D of the unit 10. Now, in FIG. 6(a), the unit 30 and the unit 50 are also depicted considering clearness of the description.

As shown in FIG. 6(a), the unit 40 is formed as circular flange-shaped member which comprises an opening potion 41 about the center thereof. The unit 40 is positioned between the unit 30 and the unit 50 and is connected through the flanges by bolt-nuts structures (not shown); the main combustion room 31 and aflame spray material reservoir 51 are fluid-communicated through an opening portion 41 having the same diameter as the main combustion room 31 of the unit 30 and the flame spray material reservoir 51 (detailed in elsewhere) of the unit 50.

The units 30, 40, and 50 are mutually connected by flanges to define the toroidal shaped cavity d and the cavity e; the unit 40 comprises a plurality of cooling water flow paths 42 for providing fluid-communication between the cavity d and the cavity e. On the other hand, the flange 54 of the unit 50 comprises a plurality of cooling water flow paths 57 for providing fluid-communication between the cavity e and the cooling water flow path 56; the cooling water flown downwardly in the cooling water flow path 37 of the unit 30 is introduced to the cooling water flow path 56 of the unit through the cooling water flow path 39, the cavity d, the cooling water flow path 42, the cavity e, and the cooling water flow path 57.

Furthermore, the unit 40 is provide with the flame spray material supply port 43 for supplying the powder (P) of the flame spray material, a hydrogen gas supply port 44 for supplying the hydrogen as the fuel, and the oxygen gas supply port 49 for supplying the oxygen as the oxidizer and further the flame spray material reservoir 45 which is defined as the toroidal shaped spacing circumferentially surrounding the opening portion 41. The flame spray material supply port 43 is fluid-communicated to the flame spray material reservoir 45 through the first flame spray material flow path 46 while the hydrogen gas supply port 44 is fluid-connected to the flame spray material reservoir 45 through the hydrogen gas flow path 47. Furthermore, the flame spray material reservoir 45 is fluid-communicated to the opening 41 through two second spraying material flow paths 48. Also the oxygen gas supply port 49 is fluid-communicated to the opening 41 through the gas flow path.

In the unit 40, the hydrogen gas supply port and the oxygen gas supply port 49 both composed by solenoid-driven injection valves (not shown) are pulsed-driven synchronously with the supply timing of the hydrogen and oxygen gases to the sub-combustion room such that the hydrogen gas and the oxygen gas are supplied to the opening portion. It is preferred that the injections of the hydrogen and oxygen are controlled to be terminated at the same time and to be supplied with the equivalent ratio of 1.0. Furthermore, the present embodiment supplies the hydrogen gas to the opening portion 41 through the flame spray material reservoir 45 and the feature thereof will be detailed hereinafter.

In the present detonation flame spray apparatus 100, the reason why the supply ports of the flammable gas to the unit 40 as well as the sub-combustion room 16 of the unit 10 is as described below:

The hydrogen gas has lower reactivity than the reactivity of hydro-carbons such as acetylene, and hence the flammable gas in several times volume larger than the entire combustion room volume per one cycle must be requested in order to obtain compatible heat amounts. However, when this injection is conducted in one port near around the ignition point, injection time for one injection becomes longer such that the operation frequency of the flame spray could not increased. Hence, the inventors have distributed the supply ports for the flammable gases into two positions to provide the above construction which enables the supply of the flammable gas with sufficient and necessary amount within the short injection time allowing the high frequency operation.

That is to say, to the present detonation flame spray apparatus 100, first the flammable gas with sufficient and necessary amounts to support the detonation is supplied from the first supply port (the hydrogen gas supply port 13 and the oxygen gas supply port 14) and the flammable gas with sufficient and necessary amounts to accelerate and to fuse the flame spray material is supplied from the second supply port (the hydrogen gas supply port 44, and the oxygen gas supply port 49).

In turn, the unit 40 is continuously supplied with the powder (P) of the flame spray material from the flame spray material supply port 43 together with nitrogen gas (N2). In the unit 40, since the flow path axis of the first flame spray material flow path 46 and the flow path axis of the second flame spray material flow path 48 are constructed so as not to be aligned, the powder (P) flowing to downwardly in the flame spray material flow path 46 together with the nitrogen gas could not be introduced into the flame spray material flow path directly and almost all of the powder is stored transiently in the flame spray material reservoir 45.

The diameter (d1) of the present flame spray material flow path 46 is reduced to about one-half of the diameter (d2) of the hydrogen gas flow path 47 such that the flow velocity of the nitrogen gas may be enhanced, and hence the powder (P) may be supplied into the flame spray material reservoir 45 in the least nitrogen gas. Here, the one-half diameter of the flame spray material flow path 46 to the diameter (d2) of the hydrogen gas flow path 47 reduces the effects of pressure fluctuations to the flame spray material supply device (not shown) which is fluid-communicated to the flame spray material supply port 43.

Next, the supply mechanism of the flame spray material of the present embodiment will be described hereunder with referring to FIG. 7. FIGS. 7(a)-(c) illustrate schematic sequential timing diagrams for the flame spray material supply mechanism in the unit 40. In FIG. 7, for explanatory purposes, the flame spray material supply mechanism is selected and is shown in the solid lines. As shown in FIG. 7(a), in the present embodiment, the powder (P) of the flame sprayed material is continuously supplied from the flame spray material supply port 43 by the nitrogen gas, and the powder (P) flows into the flame spray material reservoir 45 through the flame spray material flow path 46 and then is stored transiently in the flame spray material reservoir 45. In this timing, the hydrogen gas supply port 44 is closed.

Next, the hydrogen gas supply port 44 is opened in the timing synchronous to the supply timing of the hydrogen and oxygen gases to the sub-combustion room 16 such that the hydrogen gas of ten times larger than the volume of the flame spray material reservoir 45 is supplied to the flame spray material reservoir 45 through the hydrogen gas supply flow path 47. As the result, as shown in FIG. 7(b), the powder (P) stored in the flame spray material reservoir 45 is immediately discharged with swirled by the hydrogen gas to the flame spray material fusion room 51 through the flame spray material flow path 48 together with the hydrogen gas. Thereafter, as shown in FIG. 7(c), when the hydrogen supply port 44 is closed depending on the timing control, subsequently the powder (P) of the flame spray material supplied from the flame spray material supply port 43 is again introduced to the flame spray material reservoir 45.

The processes shown in FIGS. 7(a)-(c) are repeated per one cycle and the powder (P) of the flame spray material is supplied intermittently and synchronously to the timing of the explosion such that the powder not being fused may be protected from escaping to the outside of the flame spray apparatus from the inside of the combustion room between the timing of the explosions. In addition, in the above described flame spray material supply mechanism, the minimized usage amount of nitrogen is required to charge the flame spray material into the flame spray material reservoir 45 and the flame spray material is substantially discharged by the hydrogen fuel gas to the combustion room such that the rush into the combustion room of the nitrogen gas which disturbs the combustion is suppressed while introducing the flame spray material efficiently into the explosion flames. As the result, the flame spray material supplied to the detonation flame spray apparatus 100 may be accelerated and fused in high ratio such that the flame spraying efficiency of the detonation flame spray apparatus 100 may significantly be enhanced.

The flame spray material supply mechanism has been described hereinbefore. Now, the unit 50, which provides the space for heating and accelerating the flame spray material and is continuous to the unit 40 at the downstream side thereof, will be explained as below:

FIG. 8 shows the vertical cross section of the unit 50 of the present embodiment. In FIG. 8, front views of both ends of the unit 50 as well as the lateral cross section along to the line E-E are also shown. As shown in FIG. 8, the unit 50 is constructed as a tubular member equipped with the flange with the double tube structure. Particularly, the unit 50 comprises an inner tube 52 which defines the flame spray material fusion room 51 and serves the space for accelerating and heating the flame spray material, an outer tube 53, and two flanges 54, 55 such that the ends of each tubes are connected to each of the flanges 54,55 in the configuration that the inner tube 52 is inserted into the outer tube 53. In the unit 50, as shown in the lateral cross section along to the line E-E, the cylindrical cavity is defined by the outer wall of the inner tube 52 and the inner wall of the outer tube 53 to provide the function of cooling water flow path 56. As mentioned above, the cooling water introduced into the unit 50 through the unit 40 flows into the cooling water flow path 56 and then flows downwardly in the unit 50.

The unit 50 has the similar construction with the unit 30 previously explained except the spiral ridge 38, and the unit 50 has shorter length than the length of the unit 30. That is to say, the present embodiment may change flexibly the total length of the flame spray material fusion room 51 by connecting adequate numbers of the unit 50 depending on fusion condition of the flame spray material the residence time of the flame spray material. Hereinbefore, the unit 50 has been explained, and now, the unit 60 comprising the squeeze mechanism for assuring the residence time of the flame spray material will be explained.

FIG. 9 shows the unit 60 of the present embodiment and FIG. 9(a) shows the vertical cross section of the unit 60 and FIG. 9 (b) shows the front view of the unit 60 viewed from the right hand side of the drawing. Here, FIG. 9(a) also illustrates the units 50, 50 as explanatory purposes.

As shown in FIG. 9, the unit 60 is shaped to a circular flange-shaped member which comprises the reduced size opening 61 in the center thereof. The unit 60 is positioned between the units 50, 50 and is connected through the flanges by bolt-nuts structure (not shown) such that reduced size opening 61 provides fluid-communication between the main combustion room 31 and the flame spray material fusion room 51.

The units 50, 60, and 50 are interconnected by the flanges to define the toroidal cavity f and the cavity g and the unit 60 is provided with a plurality of cooling water flow paths 62 for providing fluid-communication between the cavity f and the cavity g. In turn, the flange 55 of the unit 50 is provided with a plurality of cooling water flow paths 58 and the cooling water flowing downwardly in the cooling water flow paths 56 of the unit 50 is introduced to the cooling water flow paths 56 of the unit 50 through the cooling water flow paths 58, the cavity f, the cooling water path 62, the cavity g and the cooling water flow path 57.

On the other hand, the reduced size opening 61 formed at the center of the unit 60 is constructed as the void space defined by the shape with connecting two truncated cones as the upper planes thereof being connected in face to face and each of the bottom planes of the truncated cone has the same diameter with the diameter of the flame spray material fusion room 51 of the unit 50. That is to say, the reduced size opening has the shape with reduced diameter along with the longitudinal direction. Therefore, the unit 60 comprising the opening 61 with reduced diameter is inserted between two units 50 and the lateral cross section of the flame spray material fusion room 51 configured by connecting a plurality of units 50 may be reduced with respect to the longitudinal direction such that the flame spray material fusion room 51 placed at the upper stream becomes higher pressure, and hence the residence time of the flame spray material may become longer.

Above all description provides the detonation flame spray apparatus of the present invention along with the particular embodiment adopting the pipe-flange structure; however, the present invention is not limited to the above described embodiments and the combustion room (sub-combustion room, the main combustion room and the flame spray material fusion room) may be integrally formed. In addition, the described above embodiment structure may be altered within the range thought by a person skilled in the art, and so far as any embodiment which exhibits the work and effect of the present invention, must be included in the scope of the present invention.

### EXAMPLES

Hereinafter, the detonation flame spray apparatus of the present invention will be explained by using particular example; however, the present invention must not be limited by the following examples. The units shown in FIGS. 1-9 were made and the exemplary detonation flame spray apparatus was constructed and operation experiments were conducted under the following conditions.

(Apparatus Construction)

(1) Nine holes (diameter=2.58 mm), the covering ratio of 0.85 was formed to the partition wall 21 of the unit 20 and positioned at 26.5 mm from the spark plug.
(2) The inner tube 33 (main combustion room) was 20 mm in the inner diameter, and 300 mm in the length thereof. The ridge 38 (width=2 mm, height=2 mm) was formed in the pitch of 15 mm.
(3) The total length of the apparatus was 1020 mm.
(4) The inner tube 33 of the unit 30 was formed as a straight tube without the ridge 38 for a comparative example.

(Operation Condition)

(1) Oxygen (0.4 MPa) and hydrogen (0.21 MPa) were oppositely injected to the sub-combustion room 16 from the gas supply port of the unit 10 (equivalent ratio=1.0).
(2) Oxygen (1.15 MPa) and hydrogen (0.6 MPa) were oppositely injected from the gas supply port of the unit 40 (equivalent ratio 1.0). Here, the oxygen supply port 49 and the hydrogen supply port 44 were positioned at 390 mm and 370 mm, respectively from the electrode of the spark plug.
(3) The operation frequency was set to 10 Hz and the injection time duration was set to 60 ms per one injection. The injection delay time was set to be 0 (zero) and the nitrogen delay time was set to 10 ms.
(4) During the operation, the cooling water was circulated through the partition wall 21 as well as the entire apparatus. Control of the example apparatus such as the gas injections and ignitions etc. as well as data measurements and data analysis were made by a program originally developed based on the commercial measurements and control software “LabVIEW” available from National Instruments Co. Ltd.

(Detonation Performance)

To the above described apparatuses (example and comparative example), pressure measurements were conducted by placing pressure sensors S1, S2, and S3 at 410 mm, 510 mm, and 610 mm, respectively downstream from the electrode of the spark plug.

FIG. 10 shows the pressure wave profiles measured by the pressure sensors (S1-S3) placed to the example apparatus. With respect to the example, as shown in FIG. 10, S1 (position at the 410 mm downstream from the electrode of the spark plug) recorded the sharp rise of the pressure wave profile which indicated the co-propagation of the burning wave and the shock wave.

From this result in the example apparatus, it is thought that the flames is developed to the detonation just discharged from the inner tube 33 of the unit 30 (main combustion room). In addition, the propagation velocities computed from the pressure rise times and the distances between the sensors of the sensor S2 and S3 (100 mm) were about theoretical values (CJ velocity=2841 m/s) over plural trials. Furthermore, from the wave profiles of S1-S3, it is thought that stable detonations were generated in the example apparatus.

FIG. 11 shows the pressure wave profiles monitored at the pressure sensor S1-S3 placed on the comparative example. As shown in FIG. 11, no sharp rise in the pressure wave profiles was observed and the highest pressure of the S1-S3 showed fluctuations. In addition, the propagation velocities computed from the rise times of the pressure and the distance between the sensors (100 mm) were largely fluctuated around the theoretical value (CJ velocity=2841 m/s). From these results, it was concluded that the generation of the detonation became unstable in the comparative example.

(Examination of Water Cooling)

With respect to the partition wall 21 of the example apparatus, the operation without circulation of the cooling water was conducted and the blow-off occurred at 3 min. from the start. The apparatus was dismantled for the inspection thereof, the partition wall 21 was burn and damaged.

(Flame Spraying Experiment)

With respect to the apparatuses for example and comparative example, the flame spraying was conducted where aluminum particles was supplied from the flame spray material supply port 43 of the unit 40 and an aluminum plate fixed at the 50 mm distance from the open end of the apparatus. In the experiment, when considering that an application time in a popular flame spraying was about 3 min.-5 min., the pressure wave profiles were continuously measured over 10 seconds after 3 min. from the start of operation.

FIG. 12 shows the pressure wave profile measured on the pressure sensor (S2) at 3 min. from the operation start. FIG. 12(a) shows the pressure wave profile of the example and FIG. 12(b) shows the pressure wave profile of the comparative example. As shown in FIG. 12(a) of the example, the profile in which the pressure rise was not observed, i.e., extinguishment, was not substantially observed and the stable detonation was generated. In addition, an observation of a cross section of a flame sprayed film by an electron microscope was supported that a dense film with the pore ration less than 1% (0.82%) was formed.

On the other hand, as shown in FIG. 12(b) of the comparative example, many profiles without the pressure rise were observed and hence it was concluded that frequent extinguishment was occurred.

As indicated by the above experimental results, according to the present invention, the detonation flame spray apparatus, which utilizes hydrogen as the fuel thereof, with the length thereof can reduced to the practical scale (about 1000 mm). Further according to the present invention, the stable pulsed detonation with the operation frequency of 10 Hz has been attained and it was succeeded to form the flame sprayed high quality film with high density using the ceramics material (aluminum).

### BRIEF DESCRIPTION OF DRAWINGS

FIG. 1 shows a side view of the detonation flame spray apparatus of the present embodiment.

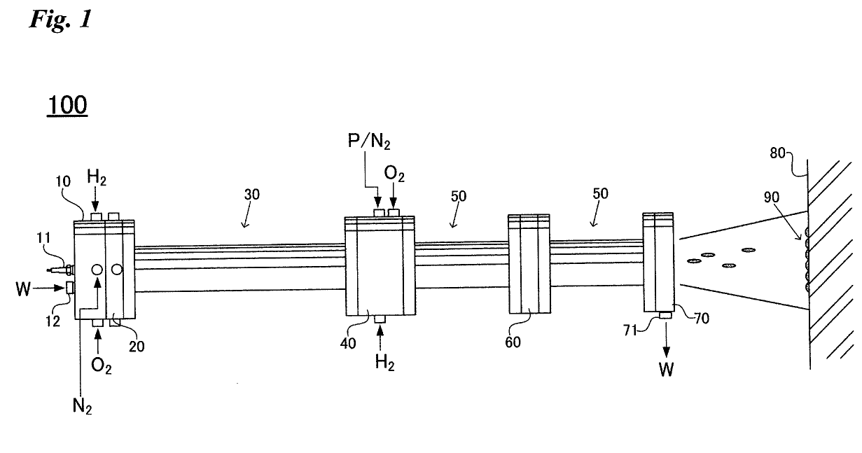

FIG. 2 shows a vertical cross section of the detonation flame spray apparatus of the present embodiment.

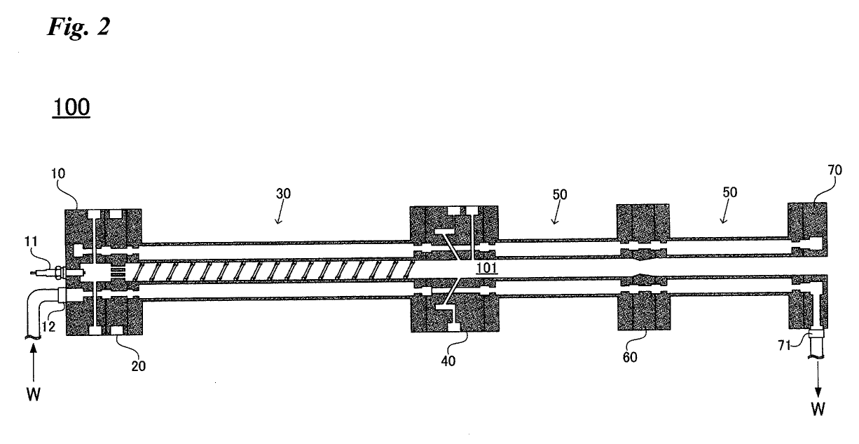

FIG. 3 shows a unit 10 and a unit 20 of the present embodiment.

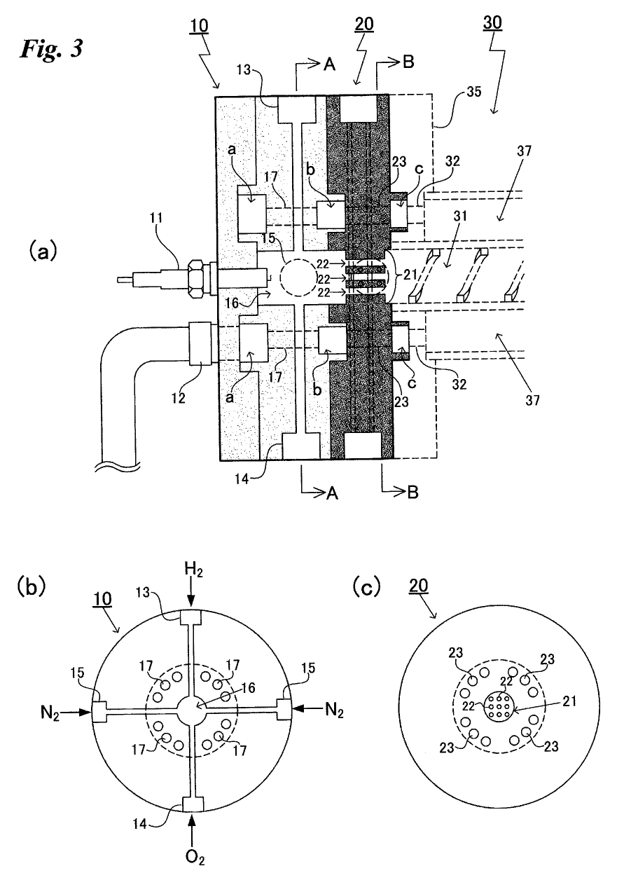

FIG. 4 shows a unit 30 of the present embodiment.

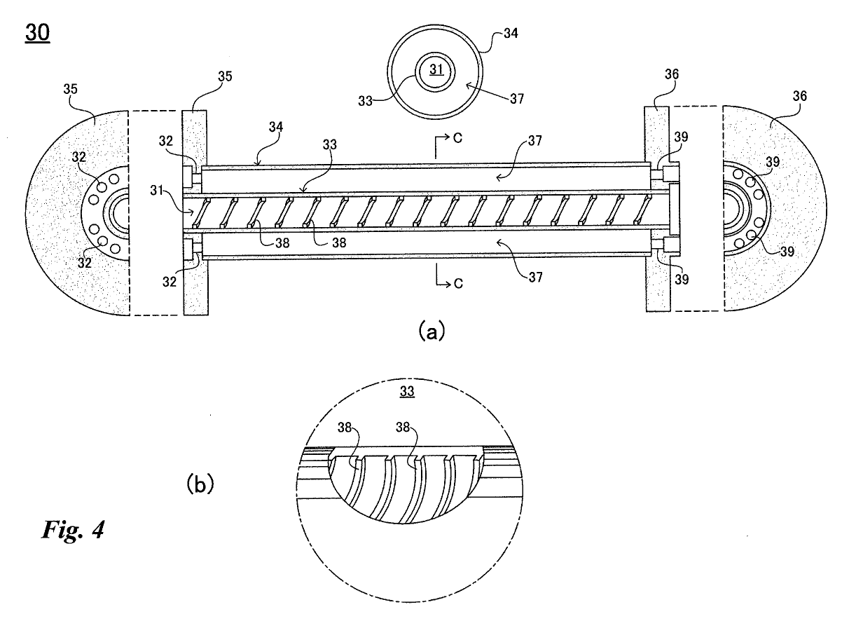

FIG. 5 shows a unit 20 of the present embodiment.

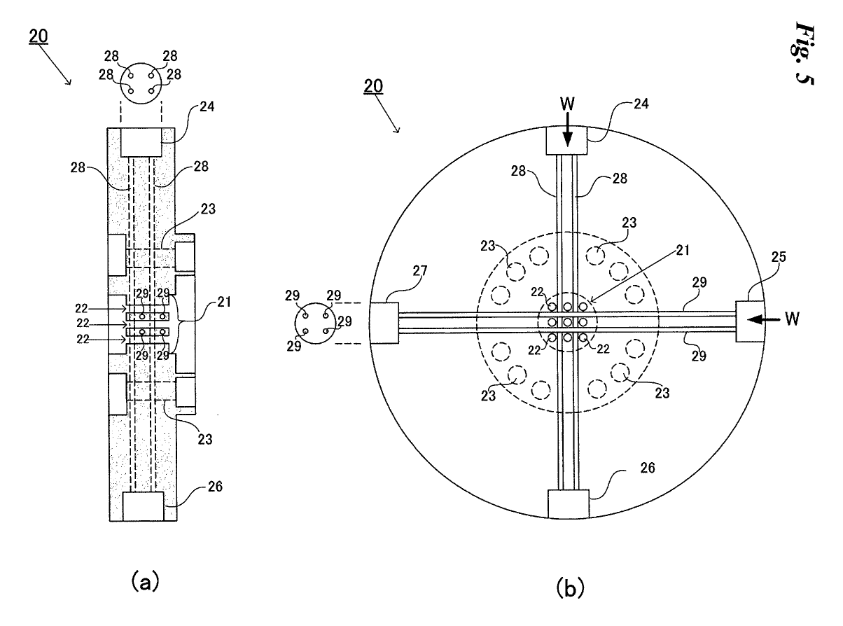

FIG. 6 shows a unit 40 of the present embodiment.

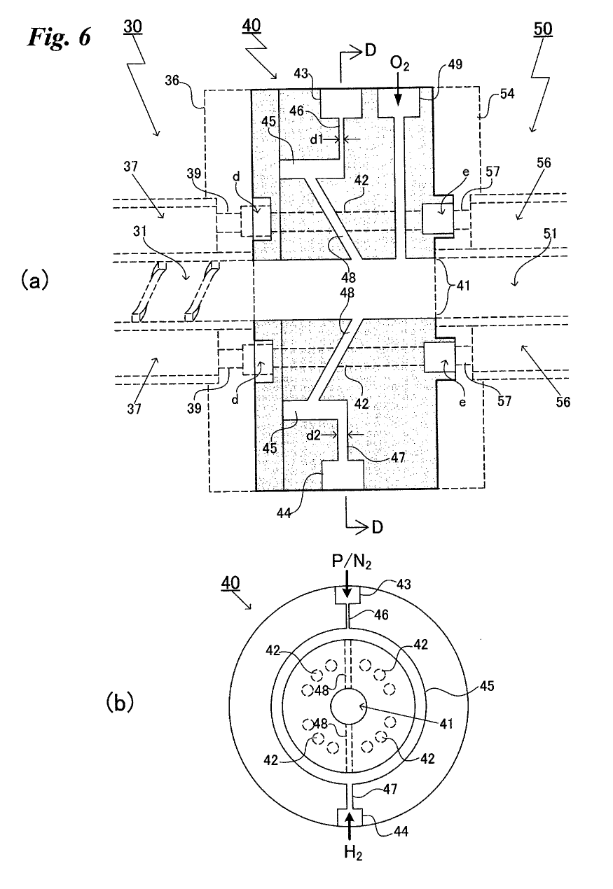

FIG. 7 shows an operation mechanism of a flame spray material supply mechanism of the present embodiment.

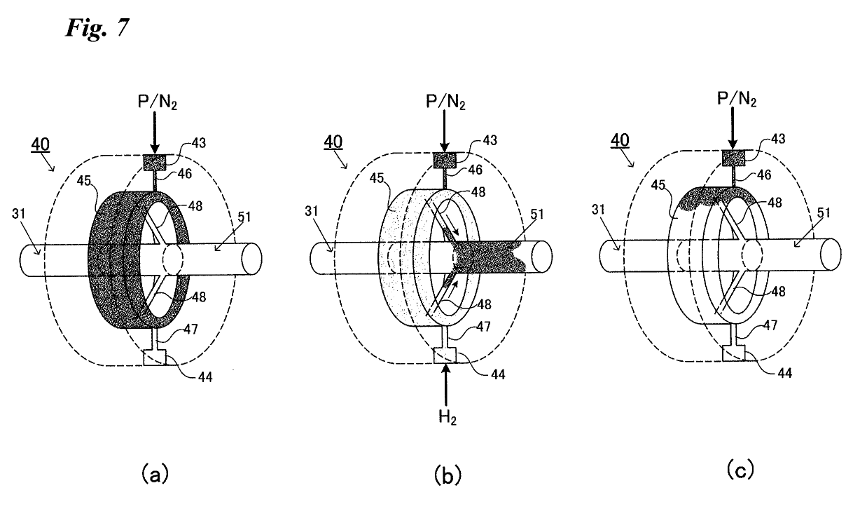

FIG. 8 shows a drawing of a unit 50 of the present embodiment.

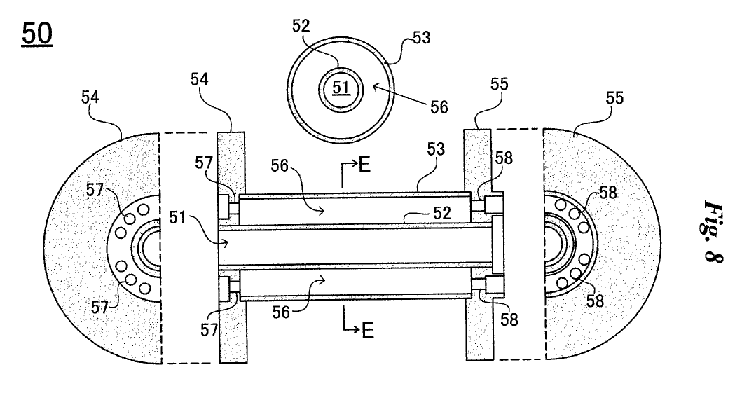

FIG. 9 shows a unit 60 of the present embodiment.

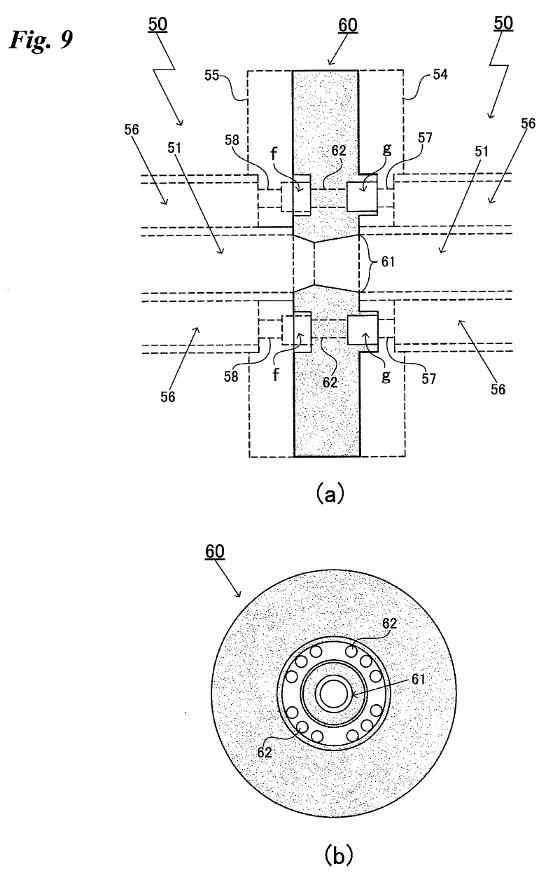

FIG. 10 shows a pressure wave profile in an apparatus of the present embodiment.

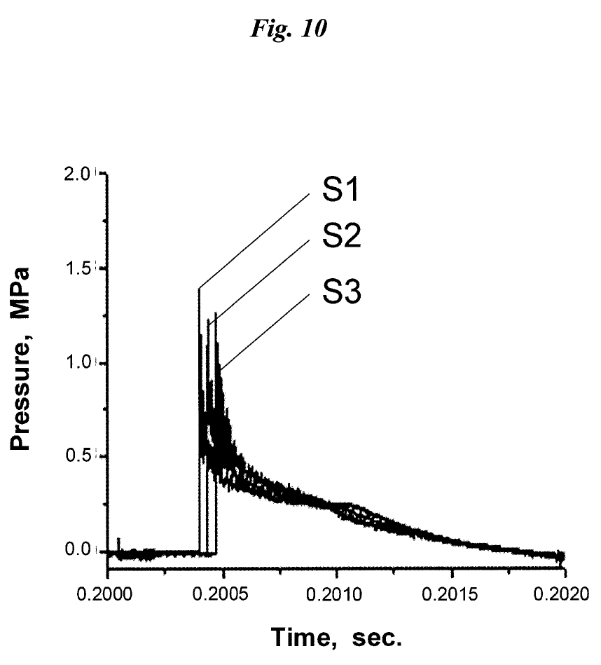

FIG. 11 shows a pressure wave profile in an apparatus of the present embodiment.

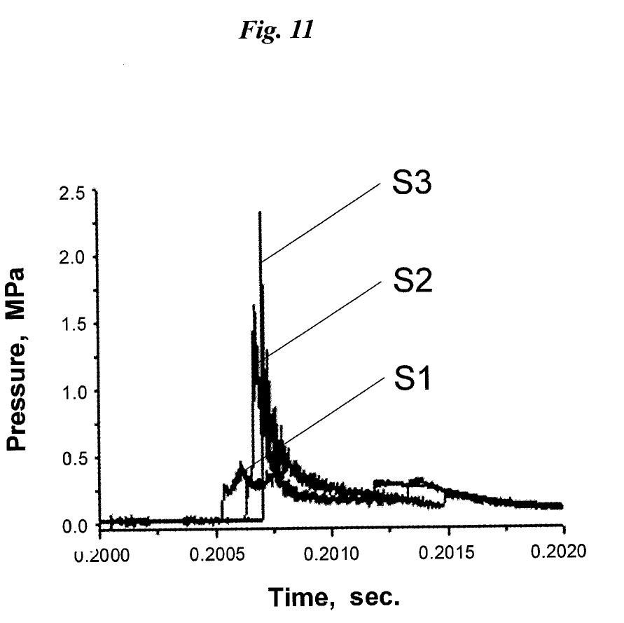

FIG. 12 shows pressure wave profiles in apparatuses of example and comparative embodiments.

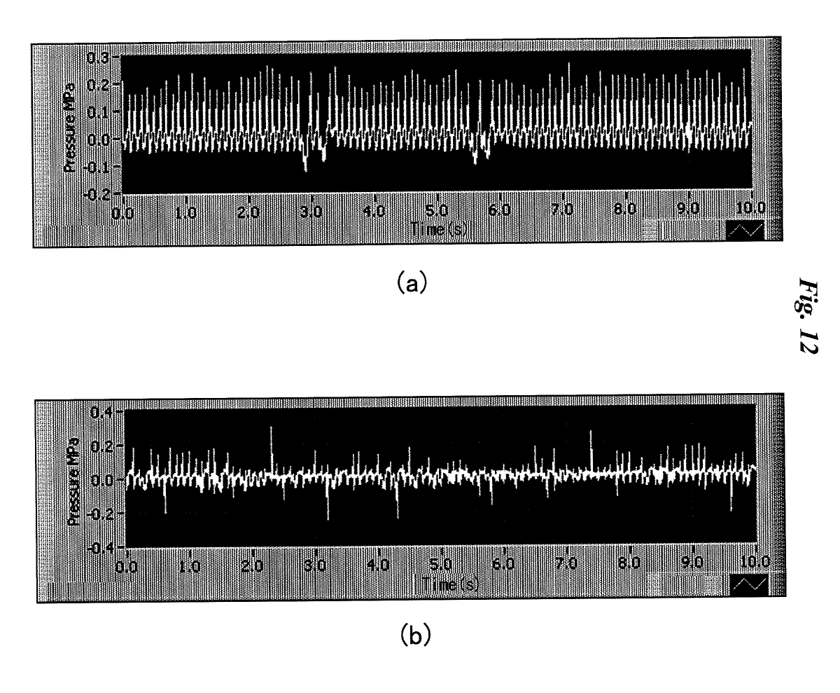

### DESCRIPTION OF REFERENCE NUMERAL

10—unit, 11—ignition means, 12—cooling water inlet port, 13—hydrogen gas inlet port, 14—oxygen gas supply port, 15—nitrogen gas supply port, 16—sub-combustion room, 17—cooling water flow path, 20—unit, 21—partition wall, 22—through hole, 23—cooling water flow path, 24—cooling water inlet port, 25—cooling water inlet port, 26—cooling water output port, 27—cooling water output port, 28—vertical flow path, 29—lateral flow path, 30—unit, 31—main combustion room, 32—cooling water flow path, 33—inner tube, 34—outer tube, 35—flange, 36—flange, 37—cooling water flow path, 38—ridge, 39—cooling water flow path, 40—unit, 41—opening, 42—flow path, 43—flame spray material supply port, 44—hydrogen gas supply port, 45—flame spray material reservoir, 46—first flame spray material flow path, 47—hydrogen gas flow path, 48—second flame spray material flow path, 49—oxygen gas supply port, 50—unit, 51—flame spray material fusion room, 52—inner tube, 53—outer tube, 54—flange, 55—flange, 56—cooling water flow path, 57—cooling water flow path, 58—flow path, 60—unit, 61—reduced opening, 62—cooling water flow path, 70—unit, 71—cooling water output port, 80—substrate, 90—film, 100—detonation flame spray apparatus, 101—combustion room

1. A detonation flame spray apparatus, said apparatus comprising a combustion room, a pulsed ignition means and being disposed at a closed end of said combustion room, a gas supply means for supplying a fuel and an oxidizer intermittently to said combustion room and synchronously driven to said ignition means, a flame spray material supply means for supplying flame spray material to said combustion room, a cooling medium flow path formed at an outer circumference of said combustion room, said apparatus characterized in that;
said combustion room comprising;
a sub-combustion room including said ignition means,
a main combustion room with a plurality of through holes, said main combustion room comprising a ridge spirally formed on an inner wall thereof while being separated from said sub-combustion room by a partition wall comprising a cooling medium flow path;
a flame spray material fusion room being disposed downstream of said main combustion room and providing a space for fusing said flame spray material;
wherein said gas supply means comprises a first and a second hydrogen injection means for supplying hydrogen as said fuel and a first and a second oxygen injection means for supplying oxygen as said oxidizer,
said first hydrogen injection means and said first oxygen injection means are disposed with injection directions thereof aligned oppositely each other in said sub-combustion room,
said second oxygen injection means and said flame spray material supply means are disposed between said main combustion room and said flame spray material fusion room, and
said flame spray material supply means comprises said second hydrogen injection means and flame spray material is supplied to said combustion room together with hydrogen gas injected by said second hydrogen injection means.

2. The detonation flame spray apparatus of claim 1, wherein said flame spray material supply means comprises a flame spray material reservoir as a space for storing transiently said flame spray material, a means for supplying said flame spray material to said flame spray material reservoir through a first flame spray material flow path, a hydrogen gas flow path for fluid-communicating said flame spray material reservoir and said second hydrogen injection means, and a second flame spray material flow path for fluid-communicating said flame spray material reservoir and said combustion room such that said flame spray material is supplied to said combustion room through said second flame spray material flow path together with said hydrogen gas injected by said second hydrogen injection means.

3. The detonation flame spray apparatus of claim 2, wherein said flame spray material reservoir provides a toroidal shaped space around an outer circumference of said combustion room, and an axis of said first flame spray material flow path and an axis of said second flame spray material flow path is not aligned each other.

4. The detonation flame spray apparatus of claim 2, wherein a diameter of said first flame spray material flow path is smaller than a diameter of said hydrogen flow path.

5. The detonation flame spray apparatus of claim 2, wherein said cooling medium flow path for cooling said partition wall comprises vertical flow paths passing through said partition wall in a vertical direction and lateral flow paths passing through said partition wall in a horizontal direction such that said vertical flow paths and said horizontal flow paths are disposed in a lattice shape.

6. The detonation flame spray apparatus of claim 2, wherein said flame spray material fusion room comprises a squeeze part with which lateral cross section thereof is partially reduced.

7. A detonation flame spray apparatus, said apparatus comprising a combustion room, a pulsed ignition means and being disposed at a closed end of said combustion room, a gas supply means for supplying a fuel and an oxidizer intermittently to said combustion room and synchronously driven to said ignition means, a flame spray material supply means for supplying flame spray material to said combustion room, a cooling medium flow path formed at an outer circumference of said combustion room, said apparatus further characterized in that;
said combustion room comprising;
a sub-combustion room including said ignition means,
a main combustion room with a plurality of through holes, said main combustion room comprising a ridge spirally formed on an inner wall thereof while being separated from said sub-combustion room by a partition wall comprising a cooling medium flow path;
a main combustion room with a plurality of through holes and with a ridge spirally formed on an inner wall thereof while being separated from said sub-combustion room by a partition wall comprising a cooling medium flow path;
wherein said partition wall comprises a cooling medium flow path in which vertical flow paths passing through said partition wall in a vertical direction and lateral flow paths passing through said partition wall in a horizontal direction are disposed in a lattice shape;
said gas supply means comprises a first and a second hydrogen injection means for supplying hydrogen as said fuel and a first and a second oxygen injection means for supplying oxygen as said oxidizer,
said first hydrogen injection means and said first oxygen injection means are disposed with injection directions thereof aligned oppositely each other in said sub-combustion room,
said second oxygen injection means and said flame spray material supply means are disposed between said main combustion room and said flame spray material fusion room, and
said flame spray material supply means comprises said second hydrogen injection means and a flame spray material reservoir as a space for storing transiently said flame spray material, a means for supplying said flame spray material to said flame spray material reservoir through a first flame spray material flow path, a hydrogen gas flow path for fluid-communicating said flame spray material reservoir and said second hydrogen injection means, and a second flame spray material flow path for fluid-communicating said flame spray material reservoir and said combustion room such that an axis of said first flame spray material flow path and an axis of said second flame spray material flow path is not aligned each other and said flame spray material is supplied to said combustion room through said second flame spray material flow path together with said hydrogen gas injected by said second hydrogen injection means.

8. A flame spraying method using a sub-combustion room comprising an ignition means on a closed end, a main combustion room with a plurality of through holes, said main combustion room comprising a ridge spirally formed on an inner wall thereof while being separated from said sub-combustion room and by a partition wall comprising a cooling medium flow path, and a flame spray material fusion room being disposed downstream of said main combustion room while providing a space for fusing said flame spray material, said method characterized by the steps comprising;
generating initial flames by pulse-driving said ignition means and injecting oppositely hydrogen as a fuel and oxygen as an oxidizer intermittently and synchronously to said ignition means to said combustion room,
discharging turbulence discharged flows into said maim combustion room by making said initial flames passed through said plural through holes,
causing said turbulence discharged flow develop to detonation in said main combustion room,
injecting said oxygen intermittently to said combustion room synchronously with said ignition means while injecting said hydrogen intermittently together with flame spray material; and
accelerating and heating said flame spray material through said detonation in said flame spray material fusion room subsequently discharging from an open end of said combustion room in high velocities,
wherein each of said steps is conducted while a cooling media is made flown down in a cooling medium flow path formed at an outer circumference of said combustion room and in said partition wall.
